(19) United States
(12) Patent Application Publication
(10) Pub. No.: US 2025/0054324 A1
(43) Pub. Date: Feb. 13, 2025

(54) VIDEO DETECTION METHOD AND APPARATUS, DEVICE, STORAGE MEDIUM, AND PRODUCT

(71) Applicant: TENCENT TECHNOLOGY (SHENZHEN) COMPANY LIMITED, Shenzhen (CN)

(72) Inventors: Taiping YAO, Shenzhen (CN); Yang CHEN, Shenzhen (CN); Shen CHEN, Shenzhen (CN); Shouhong DING, Shenzhen (CN)

(21) Appl. No.: 18/921,497

(22) Filed: Oct. 21, 2024

Related U.S. Application Data
(63) Continuation of application No. PCT/CN2023/126646, filed on Oct. 26, 2023.

(30) Foreign Application Priority Data
Nov. 15, 2022 (CN) 202211431856.5

(51) Int. Cl. G06V 20/00; G06V 10/62; G06V 10/764; G06V 10/77; G06V 10/774; G06V 10/80; G06V 20/40; G06V 40/16; G06V 40/40

(52) U.S. Cl. CPC G06V 20/95; G06V 10/62; G06V 10/764; G06V 10/7715; G06V 10/774; G06V 10/806; G06V 20/46; G06V 40/168; G06V 40/40

(57) ABSTRACT

A video detection method includes extracting a plurality of video snippets of a target video, and extracting local features corresponding to the video snippets, respectively, based on motion information of a target object in the video snippets. The local features are configured for representing a time sequence inconsistency of the video snippets. The method further includes performing fusion on the local features to obtain a global feature of the target video, determining an authenticity probability of the target object in the target video based on the global feature, and obtaining a detection result of the target video based on the authenticity probability.

### CROSS-REFERENCE TO RELATED APPLICATIONS

This application is a continuation of International Application No. PCT/CN2023/126646, filed on Oct. 26, 2023, which claims priority to Chinese Patent Application No. 202211431856.5, filed with the China National Intellectual Property Administration on Nov. 15, 2022 and entitled “VIDEO DETECTION METHOD AND APPARATUS, DEVICE, MEDIUM, AND PRODUCT,” which are incorporated herein by reference in their entirety.

### FIELD OF THE TECHNOLOGY

This application relates to the field of computer and communication technologies, and in particular, to a video detection method, a video detection apparatus, an electronic device, a computer-readable storage medium, and a computer program product.

### BACKGROUND OF THE DISCLOSURE

With the rapid development of computer technologies, application of video editing technologies becomes increasingly extensive, but it also poses a specific threat to network security or social security. For example, face recognition authorization may be compromised by deepfake, or the like, which has an impact on the security of a face recognition system. Therefore, the video needs to be checked to enhance cyber security or public safety.

### SUMMARY

In accordance with the disclosure, there is provided a video detection method including extracting a plurality of video snippets of a target video, and extracting local features corresponding to the video snippets, respectively, based on motion information of a target object in the video snippets. The local features are configured for representing a time sequence inconsistency of the video snippets. The method further includes performing fusion on the local features to obtain a global feature of the target video, determining an authenticity probability of the target object in the target video based on the global feature, and obtaining a detection result of the target video based on the authenticity probability.

Also in accordance with the disclosure, there is provided a non-transitory computer-readable storage medium, storing one or more computer programs that, when executed by one or more processors of an electronic device, cause the electronic device to extract a plurality of video snippets of a target video, and extract local features corresponding to the video snippets, respectively, based on motion information of a target object in the video snippets. The local features are configured for representing a time sequence inconsistency of the video snippets. The one or more programs, when executed by the one or more processors, further cause the electronic device to perform fusion on the local features to obtain a global feature of the target video, determine an authenticity probability of the target object in the target video based on the global feature, and obtain a detection result of the target video based on the authenticity probability.

Also in accordance with the disclosure, there is provided an electronic device including one or more processors, and one or more storage apparatuses storing one or more programs that, when executed by the one or more processors, cause the electronic device to extract a plurality of video snippets of a target video, and extract local features corresponding to the video snippets, respectively, based on motion information of a target object in the video snippets. The local features are configured for representing a time sequence inconsistency of the video snippets. The one or more programs, when executed by the one or more processors, further cause the electronic device to perform fusion on the local features to obtain a global feature of the target video, determine an authenticity probability of the target object in the target video based on the global feature, and obtain a detection result of the target video based on the authenticity probability.

Also in accordance with the disclosure, there is provided a system including a device that includes one or more processors, and one or more storage apparatuses storing a video detection model and one or more programs. The one or more programs, when executed by the one or more processors, cause the device to input a global feature of a target video into the video detection model to perform category discrimination on the global feature to obtain an authenticity probability of a target object in the target video, and obtain a detection result of the target video based on the authenticity probability

### BRIEF DESCRIPTION OF THE DRAWINGS

Accompanying drawings herein are incorporated into the specification and constitute a part of this specification, show embodiments that conform to this application, and are used for explaining the principle of this application together with this specification. Apparently, the accompanying drawings described below are merely some embodiments of this application, and a person of ordinary skill in the art may still derive other accompanying drawings according to the accompanying drawings without creative efforts. In the accompanying drawings:

FIG. 1 is a schematic diagram of an implementation environment involved in this application.

FIG. 2 is a flowchart of a video detection method according to an exemplary embodiment of this application.

FIG. 3 is a flowchart of another video detection method according to an exemplary embodiment of this application.

FIG. 4 is a flowchart of another video detection method according to an exemplary embodiment of this application.

FIG. 5 is a flowchart of another video detection method according to an exemplary embodiment of this application.

FIG. 6 is a flowchart of another video detection method according to an exemplary embodiment of this application.

FIG. 7 is a flowchart of another video detection method according to an exemplary embodiment of this application.

FIG. 8 is a flowchart of another video detection method according to an exemplary embodiment of this application.

FIG. 9 is a flowchart of another video detection method according to an exemplary embodiment of this application.

FIG. 10 is a flowchart of another video detection method according to an exemplary embodiment of this application.

FIG. 11 is a flowchart of a video detection method according to another exemplary embodiment of this application.

FIG. 12 is a flowchart of another video detection method according to another exemplary embodiment of this application.

FIG. 13 is a frame diagram of a model to be trained according to another exemplary embodiment of this application.

FIG. 14 is a schematic diagram showing extraction of motion information according to another exemplary embodiment of this application.

FIG. 15 is a schematic contrasting diagram of a video detection result according to another exemplary embodiment of this application.

FIG. 16 is a schematic contrasting diagram of another video detection result according to another exemplary embodiment of this application.

FIG. 17 is a structural block diagram of a data processing apparatus according to an exemplary embodiment of this application.

FIG. 18 is a schematic structural diagram of a computer system adapted to implement an electronic device according to an embodiment of this application.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with this application. On the contrary, the implementations are merely examples of an apparatus and a method which are consistent with some aspects of this application described in detail in the attached claims.

The block diagrams shown in the accompanying drawings are merely functional entities and do not necessarily correspond to physically independent entities. To be specific, the functional entities may be implemented in the form of software, or in one or more hardware modules or integrated circuits, or in different networks and/or processor apparatuses and/or microcontroller apparatuses.

The flowcharts shown in the accompanying drawings are merely exemplary descriptions, and do not necessarily include all content and operations/blocks, nor do they have to be executed in the described order. For example, some operations/blocks may further be broken down, but some operations/blocks may be merged or partially merged. Therefore, an actual execution order may change according to an actual situation.

The term “plurality of” mentioned in this application means two or more. The term “and/or” is used for describing an association relationship between associated objects and representing that three relationships may exist. For example, A and/or B may represent the following three cases: only A exists, both A and B exist, and only B exists. The character “/” generally indicates an “or” relationship between a preceding associated object and a latter associated object.

The technical solutions of the embodiments of this application relate to the technical field of artificial intelligence (AI). Before the technical solutions of the embodiments of this application are introduced, the AI technology is briefly introduced first. AI is a theory, a method, a technology, and an application system that uses a digital computer or a machine controlled by the digital computer to simulate, extend, and expand human intelligence, perceive the environment, acquire knowledge, and use the knowledge to obtain the best result. In other words, AI is a comprehensive technology of computer science, which attempts to understand essence of intelligence and produces a new intelligent machine that can respond in a manner similar to human intelligence. AI is to study the design principles and implementation methods of various intelligent machines, to enable the machines to have the functions of perception, reasoning, and decision-making.

Machine learning (ML) is a multi-field interdiscipline, and relates to a plurality of disciplines such as the probability theory, statistics, the approximation theory, convex analysis, and the algorithm complexity theory. ML specializes in studying how a computer simulates or implements a learning behavior of human to obtain new knowledge or skills and reorganize an existing knowledge structure to keep improving its performance. ML is the core of AI and a fundamental way to make computers intelligent, and is applied to various fields of AI. ML and deep learning generally include technologies such as an artificial neural network, a belief network, reinforcement learning, transfer learning, inductive learning, and learning from demonstration.

In the related art, a video-based editing detection method only relies on binary supervision at a video level to learn modeling, and subtle fake traces at a frame level are almost difficult to capture, resulting in relatively low video detection accuracy.

Therefore, the embodiments of this application provide a video detection method, a video detection apparatus, an electronic device, a computer-readable storage medium, and a computer program product, so as to improve accuracy of video detection.

The technical solutions of the embodiments of this application specifically involve the ML technology in AI, and specifically involve implementation of authenticity detection of a video based on the ML technology. The technical solutions of the embodiments of this application are described in detail below.

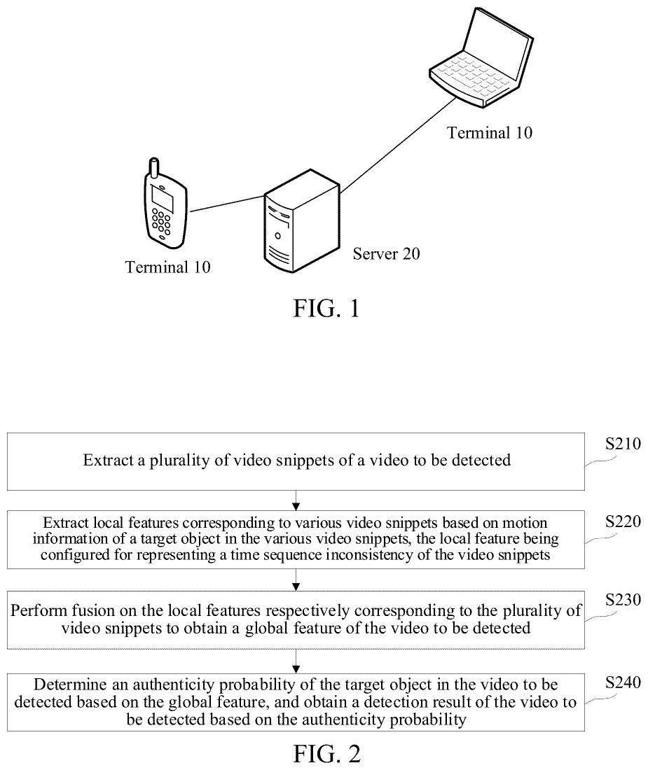

FIG. 1 is a schematic diagram of an implementation environment involved in this application. The application environment includes a terminal 10 and a server 20. The terminal 10 and the server 20 communicate with each other through a wired or wireless network.

The terminal 10 may be an initiation terminal of video detection, i.e., as an initiator of a video detection request. For example, the terminal may run an application of video authenticity detection. The application is configured for performing an authenticity detection task, and then the terminal 10 may receive a video to be detected uploaded by a use object through the application, and transmit the video to be detected to the server 20.

The server 20 may perform corresponding video detection after receiving the video to be detected, to obtain a detection result for the video to be detected. The detection result includes that the video to be detected is a real video or the video to be detected is a fake video. For example, the server 20 may be configured to: extract a plurality of video snippets of the video to be detected; extract a local feature corresponding to each of the video snippets based on motion information of a target object in each video snippet, the local feature being configured for representing a time sequence inconsistency of the video snippets; and then perform fusion on the local features respectively corresponding to the plurality of video snippets to obtain a global feature of the video to be detected, and finally determine an authenticity probability of the target object in the video to be detected based on the global feature, to obtain a detection result of the video to be detected. After the detection result of the video to be detected is generated, the detection result may be transmitted to the terminal 10, so that the terminal performs a subsequent process.

In some embodiments, the terminal 10 may also independently implement processing of the video to be detected. To be specific, the terminal 10 obtains a video to be detected, and then may extract the plurality of video snippets of the video to be detected, extract the local feature corresponding to each video snippet based on the motion information of the target object in each video snippet, then perform fusion on the local features respectively corresponding to the plurality of video snippets to obtain the global feature of the video to be detected, and finally determine the authenticity probability of the target object in the video to be detected based on the global feature, to obtain the detection result of the video to be detected. However, after the detection result of the video to be detected is obtained, the detection result may be directly displayed.

In the technical solutions of the embodiments of this application, various videos to be detected including moving objects may be processed. For example, a video to be detected including a face may be processed, and then authenticity of the face is detected. A face recognition access control system of a community is used as an example. An application on a terminal provides a face detection entry for an object. When detection is triggered, the terminal may invoke a camera to acquire a face video to be detected, and then the terminal transmits the face video to be detected to a server. The server detects, based on the face video to be detected, whether a face is a real face or a fake face, and then obtains a detection result of the video. The server transmits the detection result to the terminal, and the terminal determines, based on the detection result, whether to open a door for the object.

The foregoing terminal may be an electronic device such as a smartphone, a tablet computer, a notebook computer, a computer, an intelligent voice interaction device, an intelligent home appliance, an on-board terminal, or an aircraft. The server may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and intelligence platform, which is not limited herein.

In a specific implementation of this application, the video to be detected or/and the target object involves information related to the object. When this embodiment of this application is applied to a specific product or technology, an object permission or consent needs to be obtained, and collection, use, and processing of relevant information need to comply with relevant laws, regulations, and standards of relevant countries and regions.

Various implementation details of the technical solutions of the embodiments of this application are described in detail below.

FIG. 2 is a flowchart of a video detection method according to an embodiment of this application. The method may be applied to the implementation environment shown in FIG. 1. The method may be performed by an electronic device. The electronic device may be a terminal or a server. In some embodiments, the method may be performed by the terminal or the server, or may be performed jointly by the terminal and the server. In this embodiment of this application, an example in which the method is performed by the server is used for description. The video detection method may include operation S210 to operation S240. The detailed description is as follows.

S210: Extract a plurality of video snippets of a video to be detected.

In this embodiment of this application, the video to be detected, also referred to as a “target video,” is a video including a moving object. The moving object includes, but is not limited to, a person, an animal, a movable plant (such as a leaf swaying with the wind), or the like. The video to be detected has a specific video duration, and the video to be detected may be divided into a plurality of video snippets. Each video snippet includes a plurality of consecutive video frames. For example, if the video to be detected is a 1-minute video, the video snippet may be 15 s.

In an example, the video to be detected may be obtained from a publisher that publishes the video. For example, if a video was published on a video website, the video may be obtained from the video website.

In an example, the video to be detected may be shot by the server or the terminal.

In this embodiment of this application, an extraction process of extracting the plurality of video snippets of the video to be detected may be equidistantly dividing the video to be detected into a plurality of video snippets, or randomly dividing the video to be detected into a plurality of video snippets, or equidistantly dividing the video to be detected into a plurality of video snippets and extracting middle n frames from each of the plurality of video snippets to form a video snippet, which is not limited herein.

The video to be detected in this embodiment of this application may include one video, or may include a plurality of videos.

In a specific implementation of this application, obtained object information involves the information related to the object. When this embodiment of this application is applied to a specific product or technology, an object permission or consent needs to be obtained, and collection, use, and processing of the relevant object information need to comply with relevant laws, regulations, and standards of relevant countries and regions.

S220: Extract local features corresponding to various video snippets based on motion information of a target object in the various video snippet, the local features being configured for representing a time sequence inconsistency of the video snippets.

The video to be detected includes the target object. The target object may be any moving object. After the plurality of video snippets of the video to be detected are extracted, each video snippet also includes the target object. The target object included in the video snippet may be the same object or a plurality of different objects. For example, a video snippet may include a plurality of faces.

Since the target object is movable, the motion information of the target object is further included in the video snippet. The motion information includes, but is not limited to, a motion direction and a motion distance of the target object, and a change of the target object.

In this embodiment of this application, a difference between the video snippets may be determined based on the motion information of the target object in each video snippet, and then the local feature of the video snippet may be extracted based on the difference.

The local features are configured for representing the time sequence inconsistency of the video snippets, namely, different video snippets. Due to the motion of the target object, different video snippets have an inconsistency in a time sequence. For example, the time sequence inconsistency of a video snippet A is an inconsistency of the video snippet A relative to a video snippet B. The inconsistency means that in the time sequence, a fake part has a characteristic such as an unnatural action, for example, has a characteristic such as jittering.

S230: Perform fusion on the local features respectively corresponding to the plurality of video snippets to obtain a global feature of the video to be detected.

In this embodiment of this application, fusion is performed on the local features respectively corresponding to the plurality of video snippets. The fusion refers to a combination of a plurality of local features to enable information interaction among the local features, thereby obtaining the global feature of the video to be detected.

The local features are features at a video snippet level, and the global feature is a feature at an overall video level obtained based on the features at the video snippet level.

S240: Determine an authenticity probability of the target object in the video to be detected based on the global feature, and obtain a detection result of the video to be detected based on the authenticity probability.

In this embodiment of this application, the global feature is the feature at the overall video level obtained based on the local features at the video snippet level. Therefore, the determination of the authenticity probability of the target object in the video to be detected through the global feature is determination of the authenticity probability of the target object in the video to be detected through a combination of the video snippet level and the overall video level, so as to obtain the detection result of the video to be detected based on the authenticity probability of the target object.

The authenticity probability of the target object includes a probability that the target object is real and a probability that the target object is fake. If the target object is real, the video to be detected is also real. If the target object is fake, the video to be detected is also fake. In some embodiments, if the probability that the target object in the video to be detected is fake is greater than a preset probability threshold, it is determined that the video to be detected is a fake video. On the contrary, it is determined that the video to be detected is a real video.

In this embodiment of this application, after the plurality of video snippets of the video to be detected are extracted, the local features corresponding to the video snippets are extracted based on the motion information of the target object in the video snippets, which are used to reflect an essential time sequence inconsistency at the video snippet level, and then fusion is performed on the local features respectively corresponding to the plurality of video snippets, to obtain the global feature at the video level. The global feature may reflect the time sequence inconsistency at the video snippet level on the one hand, and may reflect a representation at the video level on the other hand, and then the authenticity probability of the target object in the video to be detected is determined based on the global feature. In this way, the authenticity probability of the target object is determined based on local details and a global entirety, so that the detection result may be more accurate.

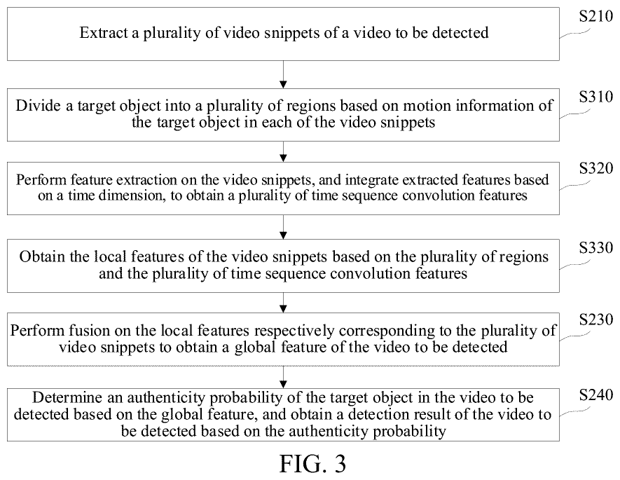

In an embodiment of this application, another video detection method is provided. The video detection method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 3, the video detection method is the same as that described in FIG. 2, except that operation S220 is expanded into operations S310-S330.

Operations S310-S330 are described in detail below.

S310: Divide the target object into a plurality of regions based on the motion information of the target object in the video snippet.

In this embodiment of this application, the motion information of the target object in the video snippet may reflect a change of the target object. The target object is divided into the plurality of regions based on the change of the target object. For example, when the target object is a face, the face may be divided into an eye region, a mouth region, and a cheek region based on a change of the eye, a change of the mouth, and a change of the cheek in the face. For another example, when the target object is the face, only the mouth and the cheek have changed in the face, the mouth may further be divided into a plurality of regions based on the change of the mouth, and the cheek may further be divided into a plurality of regions based on the change of the cheek.

S320: Perform feature extraction on the video snippets, and integrate extracted features based on a time dimension, to obtain a plurality of time sequence convolution features.

As described previously, the video snippet includes a plurality of frames. When the feature extraction is performed on the video snippet, the feature extraction may be performed on each frame. Since there is a difference in the time dimensions among the plurality of frames, the extracted features may be integrated based on the time dimension, to obtain the plurality of time sequence convolution features.

S330: Obtain the local features of the video snippets based on the plurality of regions and the plurality of time sequence convolution features.

In this embodiment of this application, after the plurality of regions and the plurality of time sequence convolution features are obtained, the local feature of the video snippet may be obtained based on a relationship between each of the regions and each of the time sequence convolution features.

In an example, a time sequence convolution feature may be assigned to each region. The relationship between the time sequence convolution feature and the region may be determined based on the time sequence convolution feature. For example, the time sequence convolution feature is a one-hot vector, and a corresponding region is determined based on a position of “1” in the one-hot vector in the whole vector.

For other detailed descriptions of operation S210 and operations S230-S240 shown in FIG. 3, reference is made to operation S210 and S230-S240 shown in FIG. 2. Details are not described herein again.

In this embodiment of this application, the target object is divided into the plurality of regions based on the motion information of the target object. To be specific, the target object is refined. The extracted features of the video snippets are integrated based on the time dimension, to obtain the time sequence convolution feature, i.e., a refinement feature. Then the local feature of the video snippet is ensured based on the plurality of regions and the plurality of time sequence convolution features, so as to accurately reflect an essential difference of the video snippets.

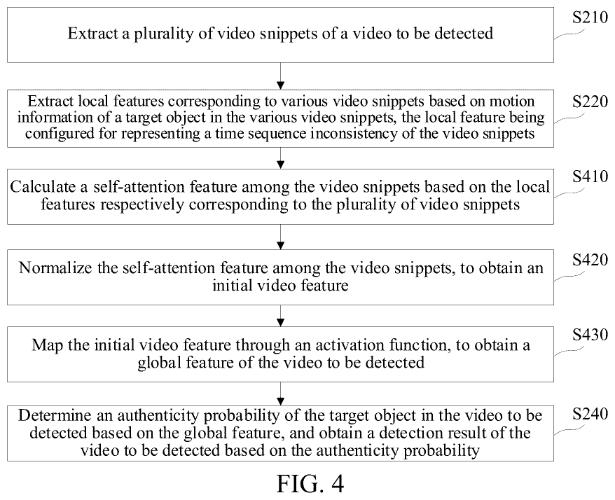

An embodiment of this application provides another video detection method. The video detection method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 4, the video detection method is the same as that described in FIG. 2, except that operation S230 shown in FIG. 2 is expanded into operations S410-S430.

Operations S410-S430 are described in detail below.

S410: Calculate a self-attention feature among the video snippets based on the local features respectively corresponding to the plurality of video snippets.

In this embodiment of this application, an inter-snippet attention mechanism is configured for obtaining information among the video snippets, and using the information of one video snippet to process information of another video snippet to implement information interaction between the video snippets. To be specific, the information is transferred from a video snippet A to a video snippet B, and the information is also transferred from the video snippet B to the video snippet A.

The self-attention feature among the video snippets may reflect an information feature obtained through information interaction across the video snippets. The information interaction among the local features respectively corresponding to the plurality of video snippets is implemented through the inter-snippet attention mechanism, and then the self-attention feature is calculated.

S420: Normalize the self-attention feature among the video snippets, to obtain an initial video feature.

In this embodiment of this application, the self-attention feature among the video snippets is normalized. For example, the self-attention feature among the video snippets may be normalized through layer-norm, to obtain the initial video feature.

S430: Map the initial video feature through an activation function, to obtain the global feature of the video to be detected.

In this embodiment of this application, the activation function may be a sigmoid function. The initial video feature is mapped to be between 0 and 1 through the sigmoid function, to obtain the global feature of the video to be detected.

For detailed descriptions of operations S210-S220 and S240 shown in FIG. 4, reference is made to operations S210-S220 and S240 shown in FIG. 2. Details are not described herein again.

In this embodiment of this application, the information interaction among the video snippets is implemented through the self-attention feature, and then the obtained global feature may reflect detailed information of the local features of the plurality of video snippets, and may further reflect overall part information of the video, to ensure accuracy of subsequent video detection.

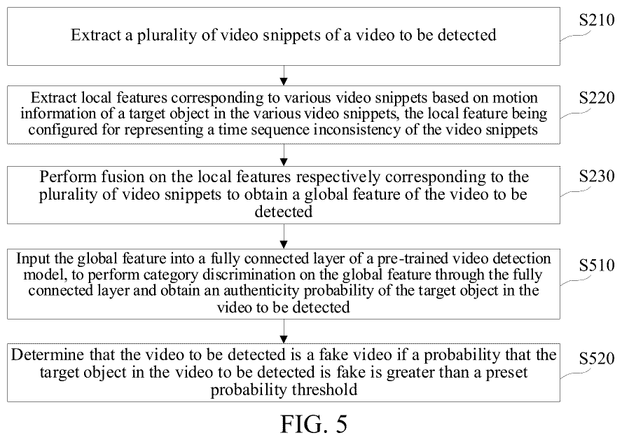

An embodiment of this application further provides another video detection method. The video detection method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 5, the video detection method is the same as that described in FIG. 2, except that operation S240 is expanded into operations S510-S520.

Operations S510-S520 are described in detail below.

S510: Input the global feature into a fully connected layer of a pre-trained video detection model, to perform category discrimination on the global feature through the fully connected layer and obtain the authenticity probability of the target object in the video to be detected.

In this embodiment of this application, there is a pre-trained video detection model. The video detection model includes a fully connected layer. The global feature is inputted into the fully connected layer, and the fully connected layer may perform category discrimination based on the global feature, to discriminate between a probability that the target object in the video to be detected to which the global feature belongs is real and a probability that the target object is fake. A sum of the probability that the target object is real and the probability that the target object is fake is 1.

S520: Determine that the video to be detected is a fake video if a probability that the target object in the video to be detected is fake is greater than a preset probability threshold.

In this embodiment of this application, if the probability that the target object in the video to be detected is fake is greater than the preset probability threshold, it indicates that the video to be detected is the fake video. If the probability that the target object in the video to be detected is fake is less than the preset probability threshold, it indicates that the video to be detected is a real video.

The preset probability threshold is a preset probability value, and a specific probability value may be flexibly adjusted based on an actual situation. In different application scenarios, the preset probability threshold is different. For example, during identification of a face in the video to be detected, the preset probability threshold is 98%. During video screening of the video to be detected, the preset probability threshold is 80%.

For other detailed descriptions of operations S210-S230 shown in FIG. 5, reference is made to operations S210-S230 shown in FIG. 2. Details are not described herein again.

In this embodiment of this application, the global feature is inputted into the fully connected layer of the video detection model, and it is further determined based on the authenticity probability of the target object in the video to be detected that the video to be detected is the fake video only when the probability that the target object is fake is greater than the preset probability threshold, further ensuring the accuracy of the detection result.

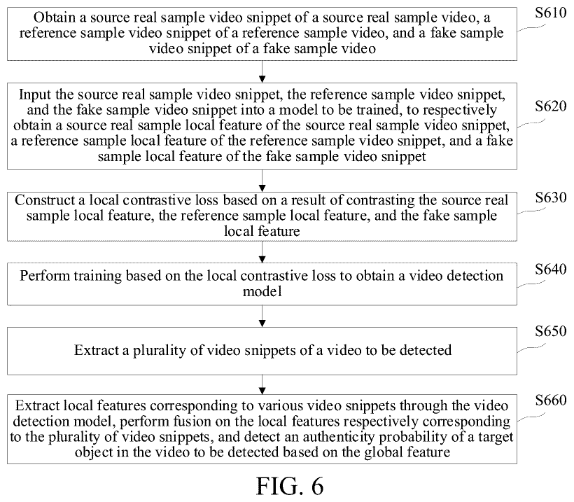

An embodiment of this application provides another video detection method. The method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. The video detection method includes: extracting a local feature corresponding to each of the video snippets through a video detection model; performing fusion on the local features respectively corresponding to the plurality of video snippets; and determining an authenticity probability of a target object in a video to be detected based on a global feature. As shown in FIG. 6, the video detection method includes a model training process and a model application process. The video detection method includes S610-S660. Operations S610-S660 are described in detail below.

S610: Obtain a source real sample video snippet of a source real sample video, a reference sample video snippet of a reference sample video, and a fake sample video snippet of a fake sample video.

In this embodiment of this application, a video snippet needs to be extracted from each of the source real sample video (which may also be referred to as a first real sample video), the reference sample video, and the fake sample video, to obtain the source real sample video snippet (which may also be referred to as a first real sample video snippet), the reference sample video snippet, and the fake sample video snippet. The source real sample video and the reference sample video both belong to a real sample video (which may also be referred to as a second real sample video). The real sample video includes the source real sample video having different content and the reference sample video having different content. The source real sample video refers to a type of real sample video. The reference sample video refers to another type of real sample video for being distinguished from the source real sample video. For example, the source real sample video is a real sample video in which an object A speaks, the fake sample video is a fake sample video in which the object A speaks, and the reference sample video is a real sample video in which the object A sings.

In an example, a sample video snippet is extracted from different sample videos (the source real sample video, the reference sample video, and the fake sample video) in the same extraction manner. For example, a first frame, a middle frame, and a last frame of the sample video are extracted to obtain the sample video snippet.

S620: Input the source real sample video snippet, the reference sample video snippet, and the fake sample video snippet into a model to be trained (also referred to as a “target model”), to respectively obtain a source real sample local feature of the source real sample video snippet, the reference sample local feature of the reference sample video snippet, and a fake sample local feature of the fake sample video snippet.

In this embodiment of this application, the source real sample video snippet, the reference sample video snippet, and the fake sample video snippet are inputted into the model to be trained. The model to be trained extracts a local feature of the sample video snippet based on the motion information of the target object in the sample video snippet. A process of extracting the local feature of the sample video snippet is similar to a process of extracting the local feature of the video snippet of the video to be detected. Details are not described herein again.

S630: Construct a local contrastive loss based on a result of contrasting the source real sample local feature, the reference sample local feature, and the fake sample local feature.

As described previously, the local feature is configured for representing a time sequence inconsistency of the video snippets. Through contrasting and learning of the source real sample local feature of the source real sample video snippet, the reference sample local feature of the reference sample video snippet, and the fake sample local feature of the fake sample video snippet, a distance between the source real sample video snippet and the reference sample video snippet is shortened through adjustment, a distance between the reference sample video snippet and the fake sample video snippet is increased through adjustment, and then the local contrastive loss is constructed. The result of contrasting may be an adjusted distance between the source real sample video snippet and the reference sample video snippet, and an adjusted distance between the reference sample video snippet and the fake sample video snippet.

S640: Perform training based on the local contrastive loss to obtain the video detection model.

In this embodiment of this application, a model parameter of the model to be trained is adjusted based on the local contrastive loss. When the loss converges, the model parameter is optimal in this case, and the video detection model is obtained through training. After the model parameter of the model to be trained is adjusted through the local contrastive loss, the model to be trained can identify which parts of the video snippet are fake.

S650: Extract a plurality of video snippets of a video to be detected.

S660: Extract local features corresponding to various video snippets through the video detection model, perform fusion on the local features respectively corresponding to the plurality of video snippets, and determine the authenticity probability of the target object in the video to be detected based on the global feature.

After the video snippets of the video to be detected are extracted, the plurality of video snippets are inputted into the video detection model. The video detection model performs a series of processing on the video snippets to obtain the authenticity probability of the target object in the video to be detected. For specific processing details of the video snippets by the video detection model, reference is made to the content in the foregoing embodiments. Details are not described again.

In this embodiment of this application, the model to be trained is trained, and then the authenticity probability of the target object in the video to be detected is determined through the video detection model, so as to be widely applied to various video detection scenes. Further, the local feature of the sample video snippet is obtained through the model to be trained, and then the local contrastive loss is constructed based on the result of contrasting the source real sample local feature, the reference sample local feature, and the fake sample local feature, so that the video detection model may focus on the time sequence inconsistency of the video snippets through the local contrastive loss, to ensure the accuracy of subsequent video detection.

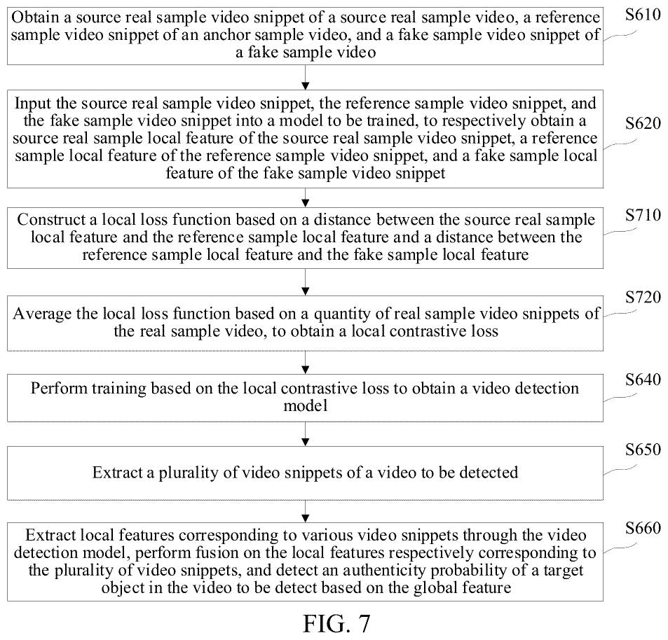

An embodiment of this application provides another video detection method. The method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 7, the video detection method is the same as that described in FIG. 6, except that operation S630 shown in FIG. 6 is expanded into operations S710-S720. Operations S710-S720 are described in detail below.

S710: Construct a local loss function based on a distance between the source real sample local feature and the reference sample local feature and a distance between the reference sample local feature and the fake sample local feature.

The source real sample local feature and the reference sample local feature are both from the real sample video, and video snippets from the two real sample videos may be regarded as a positive pair. To be specific, the source real sample local feature and the reference sample local feature are similar, but the fake video may be faked by some target objects. The source real sample video snippet and the fake sample video snippet are directly regarded as a negative pair, namely, which is not accurate. Therefore, in this embodiment of this application, the distance between the reference sample video snippet and the fake sample video snippet may be adjusted. The distance between the source real sample local feature and the reference sample local feature is shortened through adjustment, and the distance between the reference sample local feature and the fake sample local feature is increased through adjustment, so that the local loss function is constructed.

In an example, the distance between the sample video snippets may be calculated by using a cosine similarity.

In this embodiment of this application, the local loss function not only may shorten the distance between the real sample video snippets, but also may adaptively determine whether the fake sample video snippet from the fake sample video participates in the calculation of the loss function, for example, determine whether the fake sample video snippet from the fake sample video is real. Therefore, the sample video snippet suppresses contrasting with the sample video snippet of the real sample video.

S720: Average the local loss function based on a quantity of real sample video snippets of the real sample video, to obtain the local contrastive loss.

As described previously, the real sample video includes the source real sample video and the reference real sample video. If the sample video snippet from the fake sample video is real, and the fake sample video snippet of the fake sample video does not participate in the calculation of the loss function during construction of the local loss function, an average of the local loss function needs to be calculated based on the quantity of real sample video snippets of the real sample video since the loss function is constructed through the plurality of real sample video snippets, and then the local contrastive loss is obtained.

For detailed descriptions of operations S610-S620 and S640-S660 shown in FIG. 7, reference is made to operations S610-S620 and S640-S660 shown in FIG. 6. Details are not described herein again.

In this embodiment of this application, the distance between the source real sample local feature and the reference sample local feature is shortened through adjustment, and the distance between the reference sample local feature and the fake sample local feature is increased through adjustment, so that the model to be trained may perform better contrasting and learning of a difference between a real sample and a fake sample. Based on this, the local loss function is processed based on the quantity of real sample video snippets of the real sample video, so as to ensure that the local contrastive loss is more accurate.

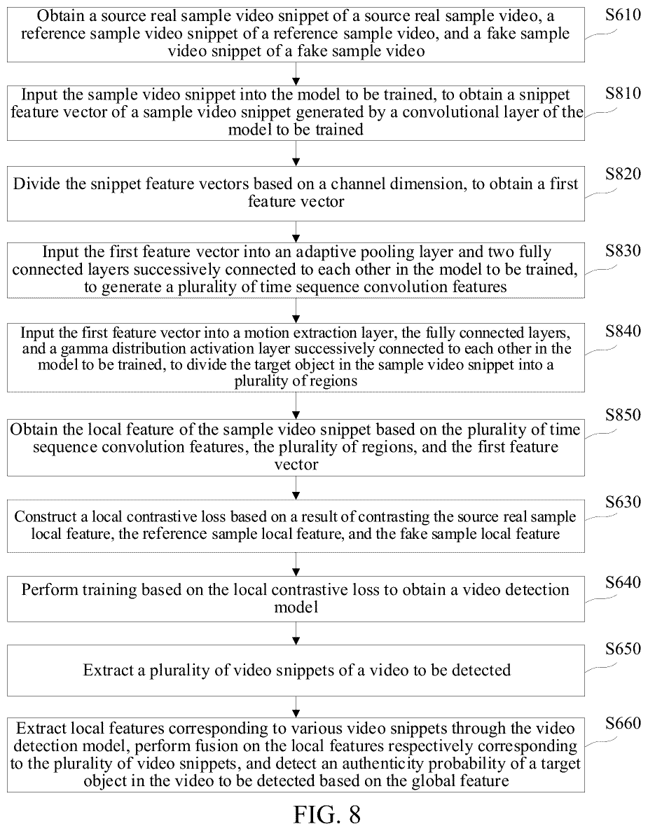

An embodiment of this application provides another video detection method. The method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 8, the video detection method is the same as that described in FIG. 6, except that operation S620 shown in FIG. 6 is expanded into operations S810-S850. Operations S810-S850 are described in detail below.

S810: Input the sample video snippet into the model to be trained, to obtain a snippet feature vector of a sample video snippet generated by a convolutional layer of the model to be trained.

In this embodiment of this application, the model to be trained includes the convolutional layer. The convolutional layer may be a 1*1 convolutional layer configured to extract a feature of the sample video snippet and generate the snippet feature vector of the sample video snippet. Specifically, the source real sample video snippet, the reference sample video snippet, and the fake sample video snippet may be respectively inputted into the model to be trained, so as to respectively obtain a snippet feature vector of the source real sample video snippet, a snippet feature vector of the reference sample video snippet, and a snippet feature vector of the fake sample video snippet through the convolutional layer.

S820: Divide the snippet feature vectors based on a channel dimension, to obtain a first feature vector.

In this embodiment of this application, each snippet feature vector is divided into two parts based on the channel dimension, namely, the first feature vector and a second feature vector, and no processing is performed on the second feature vector.

S830: Input the first feature vector into an adaptive pooling layer and two fully connected layers successively connected to each other in the model to be trained, to generate a plurality of time sequence convolution features. For example, the two fully connected layers are connected to each other and one of the two fully connected layers is connected to the adaptive pooling layer.

In this embodiment of this application, the model to be trained further includes the adaptive pooling layer connected after the convolutional layer, and two fully connected layers after the adaptive pooling layer. The first feature vector is inputted into the adaptive pooling layer. Since a quantity of input neurons in the subsequent fully connected layer is fixed, the fully connected layer cannot operate if the quantity of previously inputted neurons does not match. The first feature vector is pooled to a fixed size through the adaptive pooling layer. The fixed size corresponds to the fully connected layer. The two fully connected layers further process the time dimension to generate the plurality of time sequence convolution features.

S840: Input the first feature vector into a motion extraction layer, the fully connected layers, and a gamma distribution activation layer successively connected to each other in the model to be trained, to divide the target object in the sample video snippet into a plurality of regions.

The first feature vector is configured for processing of two branches. One branch is the adaptive pooling layer and the two fully connected layers, and the other branch is the motion extraction layer, the fully connected layer, and the gamma distribution activation layer successively connected to each other in the model to be trained. The first feature vector is inputted into the motion extraction layer. The motion extraction layer obtains a motion representation of the sample video snippet based on motion information at each pixel of an adjacent frame of the sample video snippet, and then generates a multi-dimensional one-hot vector for each pixel position of the sample video snippet through the fully connected layer and the gamma distribution activation layer. The vector is configured for selecting a time sequence convolution feature of each pixel position. Frames possessing the same vector may be regarded as the same region, and then the target object in the sample video snippet is divided into a plurality of regions.

For an execution order of operation S830 and operation S840, S830 may be performed and then S840 is performed, or S840 may be performed and then S830 is performed, or S830 and S840 may be performed simultaneously, which is not limited herein.

S850: Obtain the local features of the sample video snippets based on the plurality of time sequence convolution features, the plurality of regions, and the first feature vector.

In this embodiment of this application, tensor product processing is performed based on the plurality of time sequence convolution features and the plurality of regions, to assign a time sequence convolution feature to each region. Layer-by-layer convolution is performed on the first feature vector and the assigned time sequence convolution feature, to obtain a time sequence inconsistency feature of the sample video snippets, i.e., the local feature.

The local features respectively corresponding to the source real sample video snippet, the reference sample video snippet, and the fake sample video snippet may be obtained through S810-S850 described above.

For other detailed descriptions of S610 and S630-S660 shown in FIG. 8, reference is made to operation S610 and S630-S660 shown in FIG. 6. Details are not described herein again.

In this embodiment of this application, the model to be trained obtains the local feature of the sample video snippet through the two branches, to ensure reliability of extraction of the local feature.

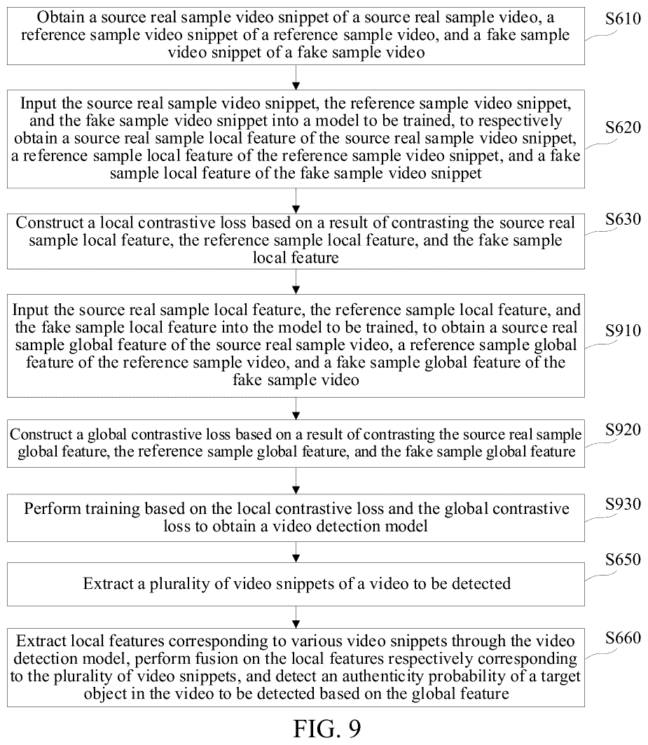

An embodiment of this application provides another video detection method. The method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 9, the video detection method is the same as that described in FIG. 6, except that operation S640 is expanded into operations S910-S930. Operations S910-S930 are described in detail below.

S910: Input the source real sample local feature, the reference sample local feature, and the fake sample local feature into the model to be trained, to obtain a source real sample global feature of the source real sample video, the reference sample global feature of the reference sample video, and a fake sample global feature of the fake sample video.

In this embodiment of this application, a plurality of source real sample local features, a plurality of reference sample local features, and a plurality of fake sample local features are respectively inputted into the model to be trained. The model to be trained is configured to: perform fusion on the plurality of source real sample local features, to obtain the source real sample global feature; perform fusion on the plurality of reference sample local features, to obtain the reference sample global feature; and perform fusion on the plurality of fake sample local features, to obtain the fake sample global feature.

S920: Construct a global contrastive loss based on a result of contrasting the source real sample global feature, the reference sample global feature, and the fake sample global feature.

As described previously, the global feature represents a representation at a video level. Through contrasting and learning of the source real sample global feature, the reference sample global feature, and the fake sample global feature, a distance between the source real sample video and the reference sample video is shortened through adjustment, and a distance between the reference sample video and the fake sample video is increased through adjustment, so as to construct the global contrastive loss.

S930: Perform training based on the local contrastive loss and the global contrastive loss to obtain a video detection model.

In this embodiment of this application, the local contrastive loss represents a result of contrasting the real sample video snippet and the fake sample video snippet, and the global contrastive loss represents a result of contrasting the real sample video and the fake sample video. A local inconsistency and a global inconsistency between a real video and a fake video are reflected through the local contrastive loss and the global contrastive loss. Then after the model to be trained is trained, the model to be trained can focus on an inconsistency among the video snippets, and a representation at the video level is formed based on information interaction between the local features.

For detailed descriptions of operations S610-S630 and S650-S660 shown in FIG. 9, reference is made to operations S610-S630 and S650-S660 shown in FIG. 6. Details are not described herein again.

In this embodiment of this application, the sample local feature is obtained through the model to be trained, and then the global contrastive loss is constructed based on the result of contrasting the source real sample global feature, the reference sample global feature, and the fake sample global feature. The model to be trained is trained based on the local contrastive loss and the global contrastive loss, so that the video detection model not only may focus on the details at the video snippet level, but also may focus on the overall content at the video level, so as to ensure the accuracy of subsequent video detection.

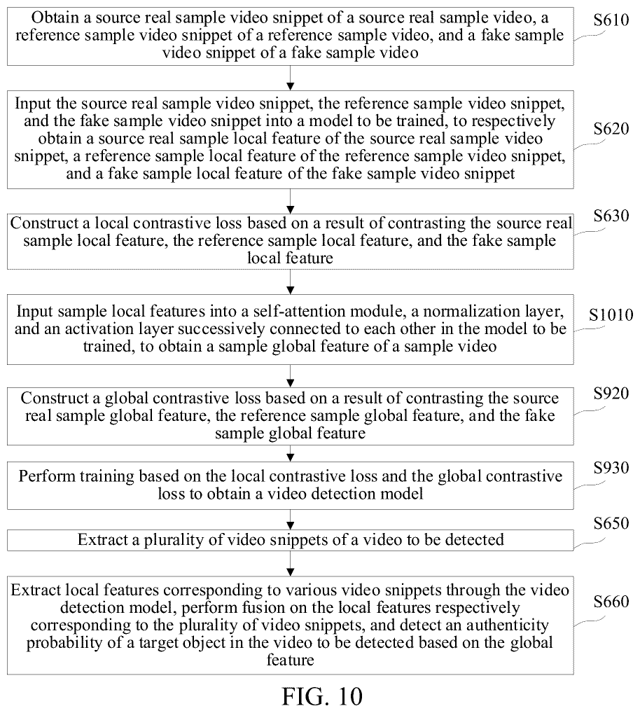

In an embodiment of this application, a video detection method is further provided. The method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 10, the video detection method is the same as that described in FIG. 9, except that operation S910 is expanded into S1010. Operation S1010 is described in detail below.

S1010: Input sample local features into a self-attention module, a normalization layer, and an activation layer successively connected to each other in the model to be trained, to obtain a sample global feature of a sample video.

In this embodiment of this application, the model to be trained includes the self-attention module, the normalization layer connected after the self-attention module, and the activation layer connected after the normalization layer.

The self-attention module is configured to implement information interaction among local features respectively corresponding to a plurality of video snippets, to calculate a self-attention feature between sample video snippets based on the plurality of sample local features. The self-attention module is an inter-snippet self-attention module. The self-attention feature between the sample video snippets may reflect an information feature obtained through the information interaction across the video snippets. The self-attention feature performs data dimension reduction, and performs data dimension increase through the normalization layer and the activation layer, to obtain the sample global feature of the sample video.

For detailed descriptions of operations S610-S630, S920-S930, and S650-S660 shown in FIG. 10, reference is made to operations S610-S630, S920-S930, and S650-S660 shown in FIG. 9. Details are not described herein again.

In this embodiment of this application, the sample global feature of the sample video is obtained through the self-attention module, the normalization layer, and the activation layer successively connected to each other in the model to be trained, to ensure reliability of the global feature.

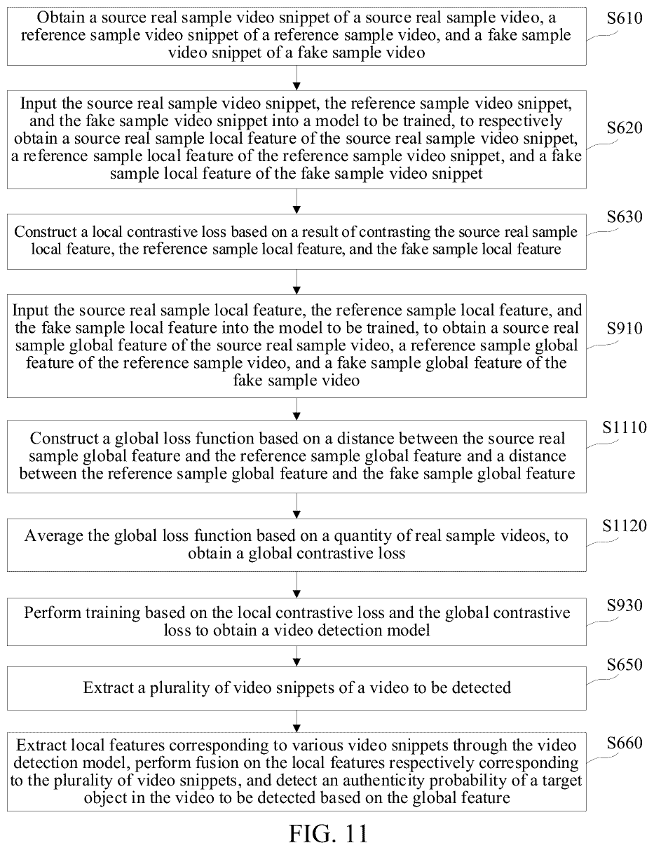

An embodiment of this application provides another video detection method. The method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 11, the video detection method is the same as that described in FIG. 9, except that operation S920 is expanded into S1110-S1120. Operations S1110-S1120 are described in detail below.

S1110: Construct a global loss function based on a distance between the source real sample global feature and the reference sample global feature and a distance between the reference sample global feature and the fake sample global feature.

In this embodiment of this application, the source real sample global feature and the reference sample global feature are both from a real sample video. The source real sample global feature is similar to the reference sample global feature. The distance between the source real sample global feature and the reference sample global feature is shortened through adjustment. However, the fake sample global feature includes a fake part. The distance between the reference sample global feature and the fake sample global feature needs to be increased through adjustment, and then the global loss function is constructed.

S1120: Average the global loss function based on a quantity of real sample videos, to obtain a global contrastive loss.

In this embodiment of this application, the real sample videos include the source real sample video and the reference sample video. The source real sample video includes a plurality of reference sample videos, and the average of the global loss function needs to be calculated based on the quantity of real sample videos, to obtain the global contrastive loss.

For detailed descriptions of operations S610-S630, S910, S930, and S650-S660 shown in FIG. 11, reference is made to operations S610-S630, S910, S930, and S650-S660 shown in FIG. 9. Details are not described herein again.

In this embodiment of this application, the distance between the source real sample global feature and the reference sample global feature is shortened through adjustment, and the distance between the reference sample global feature and the fake sample global feature is increased through adjustment, so that the model to be trained may perform better contrasting and learning of a difference between a real sample video and a fake sample video. Based on this, the global loss function is processed based on the quantity of real sample videos, so as to ensure that the global contrastive loss is more accurate.

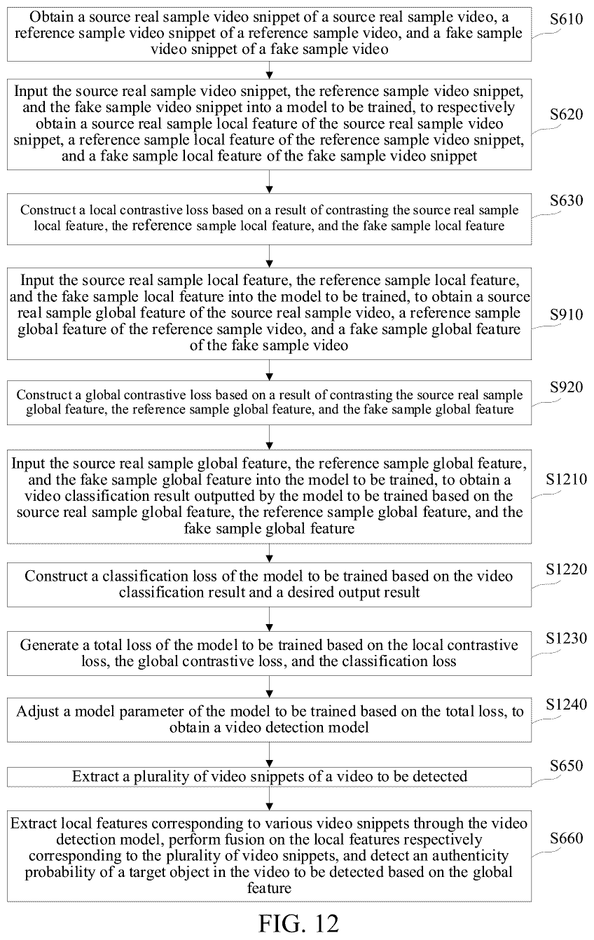

An embodiment of this application provides another video detection method. The method may be applied to the implementation environment shown in FIG. 1 or the implementation environment shown in FIG. 2. The method may be performed by a terminal or a server, or may be performed jointly by the terminal and the server. In this embodiment of this application, an example in which the method is performed by the server is used for description. As shown in FIG. 12, the video detection method is the same as S930 described in FIG. 9, except that S930 is expanded into operations S1210-S1240. Operations S1210-S1240 are described in detail below.

S1210: Input the source real sample global feature, the reference sample global feature, and the fake sample global feature into the model to be trained, to obtain a video classification result outputted by the model to be trained based on the source real sample global feature, the reference sample global feature, and the fake sample global feature.

In this embodiment of this application, the source real sample global feature is inputted into the model to be trained. The model to be trained outputs the video classification result based on the source real sample global feature. The classification result includes a probability that the source real sample video is real and a probability that the source real sample video is fake. Similarly, a video classification result is outputted based on the reference sample global feature, and a video classification result is outputted based on the fake sample global feature.

In some embodiments, the video classification result may be obtained through the fully connected layer of the model to be trained.

S1220: Construct a classification loss of the model to be trained based on the video classification result and a desired output result.

A sample video has a corresponding desired output result. The desired output result is a label carried by the sample video. For example, the label carried by the source real sample video indicates that the source real sample video is real, and the label carried by the fake sample video indicates that the fake sample video is fake. Then the classification loss of the model to be trained may be constructed based on the probability that the sample video is real, the probability that the sample video is fake, and the desired output result of the sample video.

S1230: Generate a total loss of the model to be trained based on the local contrastive loss, the global contrastive loss, and the classification loss.

In an example of this embodiment of this application, a sum of the local contrastive loss, the global contrastive loss, and the classification loss may be used as the total loss of the model to be trained.

In another example of this embodiment of this application, a weight value may be set for each of the local contrastive loss and the global contrastive loss. A weighted sum of the local contrastive loss and the global contrastive loss is calculated based on the set weight values. The total loss of the model to be trained is obtained by adding a value of the weighted sum and the classification loss together. Magnitudes of the weight value of the local contrastive loss and the weight value of the global contrastive loss may be flexibly adjusted based on an actual situation. For example, the weight value of the local contrastive loss is greater than the weight value of the global contrastive loss, the weight value of the local contrastive loss is 0.6, and the weight value of the global contrastive loss is 0.4.

S1240: Adjust a model parameter of the model to be trained based on the total loss, to obtain a video detection model.

In some embodiments, during adjustment of the model parameter of the model to be trained based on the total loss, when the total loss converges, the model parameter is optimal in this case, and the video detection model is obtained based on the optimal model parameter.

For detailed descriptions of operations S610-S630, S910-S920, and S650-S660 shown in FIG. 12, reference is made to operations S610-S630, S910-S920, and S650-S660 shown in FIG. 9. Details are not described herein again.

In this embodiment of this application, based on the local contrastive loss and the global contrastive loss, the detection result outputted by the model to be trained is close to the desired output result of the sample video by constructing the classification loss, so that the video detection result of the video detection model is more accurate.

The implementation details of the technical solution of this embodiment of this application are described in detail below by using a specific application scenario.

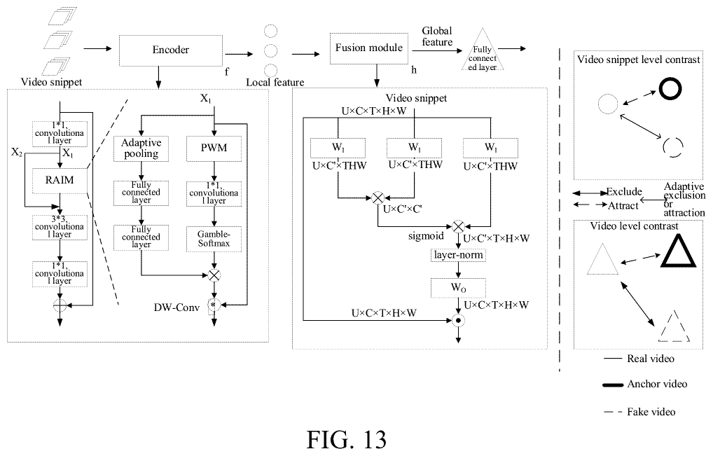

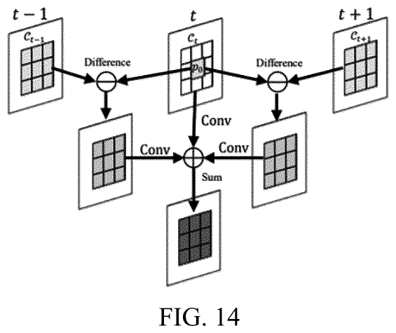

As shown in FIG. 13, an embodiment of this application provides a framework of a model to be trained. The model to be trained includes an encoder f for mining a local inconsistency, a fusion module h for fusion of video snippets, and a fully connected layer for detecting a video category.

In this application, training of the model to be trained is described by using an example in which a sample video is a video including a face.

150 frames of the face video are sampled at equal intervals by using an open source computer vision library (OpenCV) (a cross-platform computer vision and ML software library). A frame is attached to a region in which the face is located by using a multi-task convolutional neural network (MTCNN) (an open-source face detection algorithm). The region is expanded by 1.2 times with the frame as a center region and is clipped, so as to obtain a result which includes the entire face and a part of a surrounding background region. If a plurality of faces are detected in the same frame, all faces are directly saved to obtain a training sample set. A small batch of samples are selected from the training sample set based on a mini-batch method. A magnitude of a batch is 12, and U=4 video snippets are extracted. Each video snippet includes T=4 frames serving as sample data for training the model.

A video V⁺=[S₁⁺, . . . , S_{U}⁺] is from an original real sample video set N⁺ (including U sampled snippets, a size of each snippet being T×3×H×W), where T is a quantity of frames, H is a height, and W is a width. A reference video thereof is defined as another real sample video V^{a}=[S₁^{a}, . . . , S_{U}^{a}]∈N^{a} (N^{a} represents a set of reference videos). In addition, the fake sample video and the corresponding set are respectively V⁻=[S₁⁻, . . . , S_{U}⁻] and N⁻. Similarly, for Sᵢ⁺∈V⁺ in a real sample video, a reference snippet and a fake snippet of the real sample video are defined as Sⱼ^{a}∈V^{a} and Sₖ⁻∈V⁻.

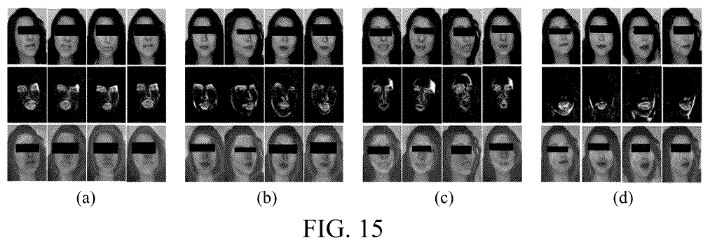

In this embodiment of this application, the encoder includes a regional inconsistency module (RAIM). The RAIM is configured to mine time sequence inconsistency features of different face regions. As shown in FIG. 14, a face is adaptively divided into r regions through a right branch (PWM-Conv-Gamble-Softmax). The r region-independent time sequence convolution is learned through a left branch (AdaP-FC-FC). Based on the two branches, each face region obtains a corresponding time sequence convolution and a corresponding time sequence inconsistency, which may be obtained through a convolution operation.

Specifically, a real sample video snippet Sᵢ⁺ is inputted into a 1*1 convolutional layer in the encoder to obtain a snippet feature vector I∈R^{C×T×H×W}, where C is a quantity of channels, and the snippet feature vector is divided into two parts based on a channel dimension, X₁∈R^{αC×T×H×W} and X₂∈R^{(1-α)C×T×H×W}. X₁ is configured for extracting a regional inconsistency, and X₂ remains unprocessed. In the left branch, X₁ first obtains Xₚ∈R^{αC×T×r} through an adaptive pooling operation (AdaP). Next, two fully connected layers FC₁ and FC₂ further process a time dimension to generate r time sequence convolution features with a kernel size of k:

$$[ \begin{matrix}{W}_{1} , & {W}_{2} , & … , & {W}_{r}\end{matrix} ] = {FC}_{2} ( ReLU ( {FC}_{1} ( AdaP ( {X}_{1} ) ) ) ) \qquad ( 1 )$$

where Wᵢ∈R^{αC×k} represents a learned time sequence convolution feature.

In the right branch, X₁ first extracts motion information at a pixel through a motion extraction layer (PWM). As shown in FIG. 14, extraction of motion information includes calculation of a difference in pixel points between two adjacent frames in different frames.

$$PWM ( {X}_{{p}_{0}} ) = {{\sum }_{p = 0}^{9}}_{p ∈ {C}_{t - 1}} {w}_{p} ( X ( {p}_{0} + p ) - X ( {p}_{0} ) ) + {{\sum }_{p = 0}^{9}}_{p ∈ {C}_{t + 1}} {w}_{p} ( X ( {p}_{0} + p ) - X ( {p}_{0} ) ) + {{\sum }_{p = 0}^{9}}_{p ∈ {C}_{t}} {w}_{p} X ( p ) \qquad ( 2 )$$

where Cₜ₋₁, Cₜ, and Cₜ₊₁ represent a 3×3 region with p₀ as a center, a point p₀+p represents a surrounding pixel of a current pixel p₀, wₚ represents a weight at a position of the point p₀+p, and PWM (Xₚ_{₀}) represents a representation of motion information of p₀.

Based on the representation, an r-dimensional one-hot vector is generated for each position through one 1×1 convolution and a gamble softmax operation. The vector is configured for selecting a time sequence convolution at each position. Positions possessing the same vector may be considered to belong to the same region, to obtain a plurality of regions.

A plurality of time sequence convolution features of the left branch and the plurality of regions of the right branch perform tensor product operations to obtain the time sequence convolution assigned to the regions. Finally, layer-by-layer convolution is performed on X₁ and the assigned time sequence convolution to obtain a time sequence inconsistency feature of snippets.

The time sequence inconsistency feature is obtained based on each real sample video snippet Sᵢ⁺, each reference sample video snippet Sa, and each fake sample video snippet Sₖ⁻, namely, the foregoing local feature.

In this embodiment of this application, RAIM is inserted before a second convolution of each ResNet block in the ResNet, and an entire encoder f is obtained based on the ResNet. As shown in FIG. 14, RAIM is inserted before the second convolution (i.e., a 3*3 convolutional layer) of each ResNet block.

In this embodiment of this application, based on the local feature of the sample video snippet, a weighted noise contrastive estimation (NCE) loss function is constructed, as shown in Equation (3).

$${L}_{NCE}^{w} ( {q}_{i} , {p}_{j} , {\{ {g}_{l} ( f ( {S}_{w}^{-} ) ) \}}_{k} ) = - log \frac{exp ( \frac{ϕ ( {q}_{i} , {p}_{j} )}{τ} )}{exp ( \frac{ϕ ( {q}_{i} , {p}_{j} )}{τ} ) + \sum {exp ( \frac{1 - ϕ ( {p}_{j} , {n}_{k} )}{2} )}^{β} exp ( \frac{ϕ ( {q}_{i} , {n}_{k} )}{τ} )} \qquad ( 3 )$$

where gₗ(⋅):R^{C}→R¹²⁸ is a mapping header, qᵢ(⋅)=gₗ(f(Sᵢ⁺)), pⱼ=gₗ(f(Sⱼ^{a})), and nₖ=gₗ(f(S_{w}⁻))ₖ. ϕ(x,y) represents a cosine similarity between normalized vectors of l₂. τ and β are respectively a temperature coefficient and an adjustable factor. The temperature coefficient is configured for controlling a discrimination degree of a model for the fake sample video snippet. A term (⋅)^{β} dynamically determines whether a snippet from the fake video is involved in the calculation of the loss function L_{NCE}^{w}. In other words, if the snippet from the fake video is real, the term is approximately 0, and hence contrasting with the snippet from the real video is suppressed; and in contrast, if the snippet from the fake video is fake, the term is approximately 1, and hence contrasting with the snippet from the real video is activated.

The local contrastive loss is defined as:

$${L}_{l} = \frac{1}{N} {{\sum }_{i = 1 … N}}_{j = 1 .. N - U} {L}_{NCE}^{w} ( {g}_{l} ( f ( {S}_{i}^{+} ) ) , {g}_{l} ( f ( {S}_{j}^{a} ) ) , {\{ {g}_{l} ( f ( {S}_{w}^{-} ) ) \}}_{k} ) \qquad ( 4 )$$

where N=|N⁺|·U and |N⁺| represent a quantity of videos in a real video set N⁺.

Based on the foregoing process, the local inconsistency representation of the video snippet may be implemented, and the snippets from the real video and the fake video may be contrasted. Then a video level representation of the sample video may be obtained through the fusion module based on the local features of the video snippets, i.e., a global feature.

The local features of the plurality of real sample video snippets Sᵢ⁺ are inputted into the fusion module. The information interaction between f(Sᵢ)∈R^{U×C′×T×H′×W′} is promoted through the fusion module. For ease of description, the local feature of the video snippet is represented by f(Sᵢ), and the local features of the plurality of real sample video snippets Sᵢ⁺ are represented by f(Vᵢ⁺).

The fusion module includes a self-attention module. Based on the self-attention module in FIG. 13, an inter-snippet attention Atten is equal to softmax (Q*K^{T}/\sqrt{C′})V. For the real sample video, Q=f(Vᵢ⁺)*W_{Q}, K=W_{K}^{T}*f(Vᵢ⁺)^{T}, and V=f(Vᵢ⁺)*W_{V}. W_{Q}, W_{K}, and W_{V} are the same, namely, W_{I}, which is a trainable parameter and configured for dimension reduction.

$$Atten = soft max ( \frac{( f ( V ) {W}_{I} ) ( {W}_{I}^{T} {f ( V )}^{T} )}{\sqrt{{C}^{′}}} ) f ( V ) {W}_{I} \qquad ( 5 )$$

The self-attention features of f(Vⱼ^{a}) and f(V_{w}⁻) may be obtained by using Equation (5).

Next, Atten is configured for weighting channels of f(V):

$$h ( f ( V ) ) = σ ( Norm ( Atten ) {W}_{O} ) \cdot f ( V ) \qquad ( 6 )$$

where W_{O} is a trainable parameter for dimension increase. Norm(⋅) and σ are respectively layer-norm and a sigmoid function.

Equation (6) is a representation at the video level, i.e., the global feature of the sample video.

Further, representations from the real video and the fake video may be obtained:

$${L}_{NCE} ( {u}_{i} , {v}_{j} , {\{ {g}_{g} ( h ( f ( {V}_{w}^{-} ) ) ) \}}_{k} ) = - log \frac{exp ( \frac{ϕ ( {u}_{i} , {v}_{j} )}{τ} )}{exp ( \frac{ϕ ( {u}_{i} , {v}_{j} )}{τ} ) + \sum exp ( \frac{ϕ ( {u}_{i} , {m}_{k} )}{τ} )} \qquad ( 7 )$$

where g_{g}(⋅):R^{C}→R¹²⁸ is a mapping header, uᵢ(⋅)=g_{g}(h(f(Vᵢ⁺)), vⱼ=g_{g}(h(f(Vᵢ^{a}))), and mₖ=g_{g}(h(f(V_{w}⁻)))ₖ. ϕ(x,y) represents a cosine similarity between normalized vectors of l₂. τ represents a temperature coefficient.

The contrastive loss at the video level may be written as:

$${L}_{g} = \frac{1}{\vert {N}^{+} \vert} {\sum }_{i = 1 … \vert {N}^{+} \vert} {L}_{NCE} ( {g}_{g} ( h ( f ( {V}_{i}^{+} ) ) ) , {g}_{g} ( h ( f ( {N}^{a} ) ) ) , {g}_{g} ( h ( f ( {N}^{-} ) ) ) ) \qquad ( 8 )$$

where h(f(Vᵢ⁺))=h(f(S₁⁺), . . . , f(S_{U}⁺)), h(f(N^{a}))={h(f(Vᵢ^{a}))}ⱼ, h(f(N⁻))={h(f(V_{w}⁻))}ₖ.

In this embodiment of this application, after the global features at the video level of the sample video snippet are obtained, the global features are inputted into the fully connected layer FC for category determination. The loss function of the fully connected layer may use a binary cross entropy loss L_{ce}.

Therefore, a total loss of the entire model to be trained is L=L_{ce}+λ₁L₁+λ₂L₂. λ₁ and λ₂ are respectively balance factors to adjust different terms.

Contrasting and learning of the mapping headers in the local contrastive loss and the global contrastive loss are not used during model inference.

In some embodiments, the encoder uses a skeleton network of ResNet-50, and a weight is pre-trained on ImageNet. In addition, during the training, a size of each inputted picture frame is adjusted to 224×224. Network optimization is performed on the binary cross entropy loss by using the Adam optimization algorithm, and training is performed for 60 cycles and for 45 cycles in a cross-dataset generalization experiment. An initial learning rate is 10⁻⁴ and decreases by one tenth every 10 cycles. During the training, only horizontal flip is used for data expansion.

The video detection model is obtained by training the model to be trained through the foregoing process. During application of the video detection model, U=8 snippets are sampled, each of the snippets including T=4 frames for testing. A test video is divided into 8 snippets at an equal spacing, and then middle 4 frames are extracted from each snippet to form inputs of the test video. Then the frames are inputted into the pre-trained model to obtain a probability value, which is configured for representing a probability that the video is a face editing video (a larger probability value indicates a higher probability that the face in the video is edited).

As shown in FIG. 15, FIG. 15 shows a visualization result of an output feature, and an output of a network is visualized to show a region of interest of a model. A fake mask in a second row is from a difference between a fake video and an original video. To be specific, a white prominent part in the second row is a difference between the fake video and the real video. For a fake type of Deepfakes (face fakes) generated by deep learning tools, as shown in (a) of FIG. 15, an activation map of a network covers almost the whole face region. Similarly, as shown in (c) of FIG. 15, attention is paid to a face swapping part of a FaceSwap type through this embodiment of this application. As shown in (b) and (d) of FIG. 15, fake local regions can still be located on more challenging Face2Face (expression fakes) and Neural Textures (mouth fakes).

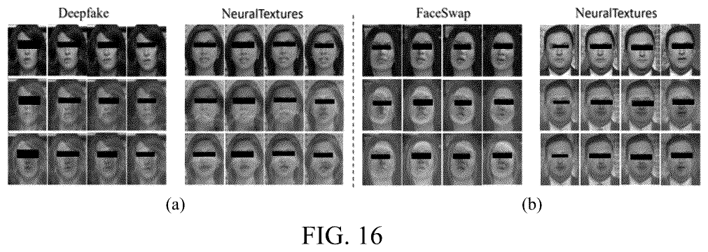

This embodiment of this application provides a method intended to adaptively grab a dynamic local representation for learning a local contrasting inconsistency. The method is compared with ordinary time sequence convolution herein, and a corresponding attention diagram is visualized, as shown in FIG. 16. Weights of the ordinary time sequence convolution are content-independent and equally treat all face regions. Therefore, attention is easily paid to incomplete fake regions (left parts in a second row in (a) of FIG. 16) or false regions (right parts in a second row in (a) of FIG. 16). Conversely, in left parts and right parts in a third row in (a) of FIG. 16, in the embodiments of this application, a region-specific time sequence convolution is generated to extract dynamic time sequence information, and thus a more complete representation of a time sequence inconsistency may be used for fake identification, to enable more accurate identification of a fake region.

Level contrasting is performed to pull close positive samples and at the same time push away negative samples at snippet and video levels. To visualize the impact of the level contrasting, (b) of FIG. 16 directly shows the impact of the level contrasting on network activation. Those tiny fake regions may be observed from the left parts and the right parts of a third row in (b) of FIG. 16. The level contrastive loss plays a regular role, so that the video detection model pays attention to more accurate parts. In addition, a large-area fake region guides the model to focus on a more comprehensive fake position.

Embodiments of an apparatus of this application are described, which may be configured to perform the video detection method in the foregoing embodiments of this application. For details not disclosed in the apparatus embodiment of this application, reference is made to the foregoing embodiments of the video detection method in this application.

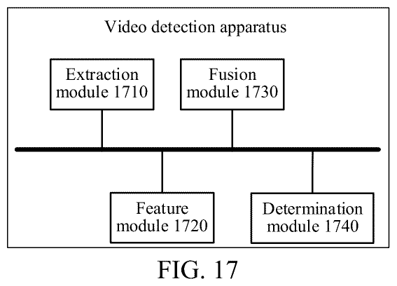

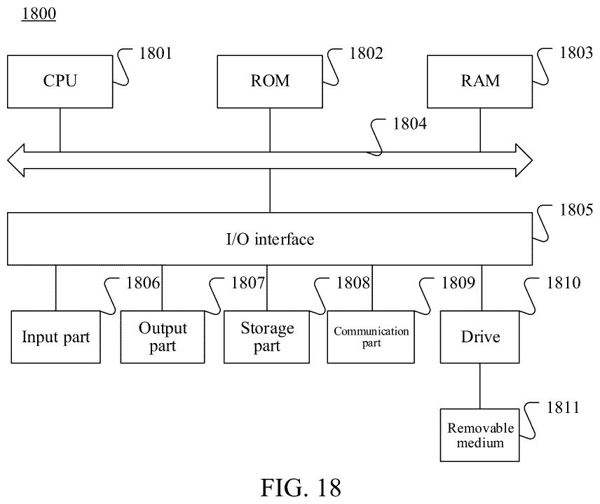

An embodiment of this application provides a video detection apparatus. As shown in FIG. 17, the video detection apparatus may be configured in a terminal or a server. The apparatus includes:
an extraction module 1710, configured to extract a plurality of video snippets of a video to be detected;
a feature module 1720, configured to extract a local feature corresponding to each of the video snippets based on motion information of a target object in each video snippet, the local feature being configured for representing a time sequence inconsistency of the video snippets;
a fusion module 1730, configured to perform fusion on the plurality of local features to obtain a global feature of the video to be detected; and
a determination module 1740, configured to determine an authenticity probability of the target object in the video to be detected based on the global feature, to obtain a detection result of the video to be detected.

In an embodiment of this application, based on the foregoing solution, the feature module 1720 is further configured to: divide the target object into a plurality of regions based on the motion information of the target object in the video snippet; perform feature extraction on the video snippets, and integrate extracted features based on a time dimension, to obtain a plurality of time sequence convolution features; and obtain the local features of the video snippets based on the plurality of regions and the plurality of time sequence convolution features.

In an embodiment of this application, based on the foregoing solution, the fusion module 1730 is configured to: calculate a self-attention feature among the video snippets based on the local feature corresponding to each of the plurality of video snippets; normalize the self-attention feature among the video snippets, to obtain an initial video feature; and map the initial video feature through an activation function, to obtain the global feature of the video to be detected.

In an embodiment of this application, based on the foregoing solution, the determination module 1740 is further configured to: input the global feature into a fully connected layer of a pre-trained video detection model, to perform category discrimination on the global feature through the fully connected layer and obtain the authenticity probability of the target object in the video to be detected; and determine that the video to be detected is a fake video if a probability that the target object in the video to be detected is fake is greater than a preset probability threshold.

In an embodiment of this application, based on the foregoing solution, the local feature corresponding to each video snippet is extracted through the video detection model, fusion is performed on the local features respectively corresponding to the plurality of video snippets, and the authenticity probability of the target object in the video to be detected is determined based on the global feature. The apparatus further includes a training module, configured to: obtain a first real sample video snippet of a first real sample video, a reference sample video snippet of a reference sample video, and a fake sample video snippet of a fake sample video, the first real sample video and the reference sample video belonging to a second real sample video including different content; input the first real sample video snippet, the reference sample video snippet, and the fake sample video snippet into a model to be trained, to respectively obtain a first real sample local feature of the first real sample video snippet, the reference sample local feature of the reference sample video snippet, and a fake sample local feature of the fake sample video snippet; construct a local contrastive loss based on a result of contrasting the first real sample local feature, the reference sample local feature, and the fake sample local feature; and perform training based on the local contrastive loss to obtain the video detection model.

In an embodiment of this application, based on the foregoing solution, the training module is further configured to: construct a local loss function based on a distance between the first real sample local feature and the reference sample local feature and a distance between the reference sample local feature and the fake sample local feature; and average the local loss function based on a quantity of real sample video snippets corresponding to the second real sample video, to obtain the local contrastive loss.

In an embodiment of this application, based on the foregoing solution, the training module is further configured to: input the first real sample video snippet, the reference sample video snippet, and the fake sample video snippet into the model to be trained, to obtain snippet feature vectors respectively corresponding to the first real sample video snippet, the reference sample video snippet, and the fake sample video snippet generated by a convolutional layer of the model to be trained; divide the snippet feature vectors based on a channel dimension, to obtain a first feature vector; input the first feature vector into an adaptive pooling layer and two fully connected layers successively connected to each other in the model to be trained, to generate the plurality of time sequence convolution features; input the first feature vector into a motion extraction layer, the fully connected layers, and a gamma distribution activation layer successively connected to each other in the model to be trained, so as to divide the target objects in the first real sample video snippet, the reference sample video snippet, and the fake sample video snippet into the plurality of regions; and obtain local features respectively corresponding to the first real sample video snippet, the reference sample video snippet, and the fake sample video snippet based on the plurality of time sequence convolution features, the plurality of regions, and the first feature vector.

In an embodiment of this application, based on the foregoing solution, the training module is further configured to: input the first real sample local feature, the reference sample local feature, and the fake sample local feature into the model to be trained, to obtain a first real sample global feature of the first real sample video, the reference sample global feature of the reference sample video, and a fake sample global feature of the fake sample video; construct a global contrastive loss based on a result of contrasting the first real sample global feature, the reference sample global feature, and the fake sample global feature; and perform training based on the local contrastive loss and the global contrastive loss to obtain the video detection model.

In an embodiment of this application, based on the foregoing solution, the training module is further configured to: input the first real sample local feature, the reference sample local feature, and the fake sample local feature into a self-attention module, a normalization layer, and an activation layer successively connected to each other in the model to be trained, to obtain a sample global feature of a sample video.

In an embodiment of this application, based on the foregoing solution, the training module is further configured to: construct a global loss function based on a distance between the first real sample global feature and the reference sample global feature and a distance between the reference sample global feature and the fake sample global feature; and average the global loss function based on a quantity of second real sample videos, to obtain the global contrastive loss.

In an embodiment of this application, based on the foregoing solution, the training module is further configured to: input the first real sample global feature, the reference sample global feature, and the fake sample global feature into the model to be trained, to obtain a video classification result outputted by the model to be trained based on the first real sample global feature, the reference sample global feature, and the fake sample global feature; construct a classification loss of the model to be trained based on the video classification result and a desired output result; generate a total loss of the model to be trained based on the local contrastive loss, the global contrastive loss, and the classification loss; and adjust a model parameter of the model to be trained based on the total loss, to obtain a video detection model.

The apparatus provided in the foregoing embodiment and the method provided in the foregoing embodiment belong to the same idea. Specific manners in which the modules and units perform operations have been described in detail in the method embodiments. Details are not described herein again.

An embodiment of this application further provides an electronic device, including one or more processors, and a storage apparatus, the storage apparatus being configured to store one or more computer programs, the one or more computer programs, when executed by the one or more processors, causing the electronic device to implement the foregoing video detection method.

FIG. 18 is a schematic structural diagram of a computer system adapted to implement an electronic device according to an embodiment of this application.

The computer system 1800 of the electronic device shown in FIG. 18 is merely an example, and does not constitute any limitation on functions and usage scope of the embodiments of this application. The electronic device may be a terminal or a server.

As shown in FIG. 18, the computer system 1800 includes a central processing unit (CPU) 1801, which may perform various suitable actions and processes based on a program stored in a read-only memory (ROM) 1802 or a program loaded from a storage part 1808 into a random access memory (RAM) 1803, for example, perform the method in the foregoing embodiment. The RAM 1803 further has various programs and data required for system operation stored therein. The CPU 1801, the ROM 1802, and the RAM 1803 are connected to each other through a bus 1804. An input/output (I/O) interface 1805 is also connected to the bus 1804.

In some embodiments, the following components are connected to the I/O interface 1805: an input part 1806 including a keyboard, a mouse, or the like; an output part 1807 including a cathode ray tube (CRT), a liquid crystal display (LCD), a speaker, or the like; the storage part 1808 including a hard disk, or the like; and a communication part 1809 including a network interface card such as a local area network (LAN) card and a modem. The communication part 1809 performs communication processing by using a network such as the Internet. A drive 1810 is also connected to the I/O interface 1805 as required. A removable medium 1811 such as a magnetic disk, an optical disk, a magneto-optical disk, or a semiconductor memory is installed on the drive 1810 as required, so that a computer program read from the removable medium is installed into the storage part 1808 as required.

Particularly, according to the embodiments of this application, the process described by referring to the flowchart in the above may be implemented as a computer program. For example, this embodiment of this application includes a computer program product, including a computer program carried on a computer-readable medium, the computer program including program code for performing the method shown in the flowchart. In such an embodiment, the computer program may be downloaded from a network through the communication part 1809 and installed, and/or installed from the removable medium 1811. When the computer program is executed by the CPU 1801, various functions defined in the system of this application are executed.

The computer-readable medium described in the embodiments of this application may be a computer-readable signal medium or a computer-readable storage medium or any combination of the above. The computer-readable storage medium may be, for example, an electric, magnetic, optical, electromagnetic, infrared, or semi-conductive system, apparatus, or device, or any combination of the above. A more specific example of the computer-readable storage medium may include but is not limited to: an electrical connection having one or more wires, a portable computer disk, a hard disk, a RAM, a ROM, an erasable programmable ROM (EPROM), a flash memory, an optical fiber, a portable compact disk ROM (CD-ROM), an optical storage device, a magnetic storage device, or any appropriate combination of the above. In this application, a computer-readable signal medium may include a data signal being in a baseband or propagated as a part of a carrier wave, which carries a computer-readable computer program. A data signal propagated in such a way may have a plurality of forms, including but not limited to, an electromagnetic signal, an optical signal, or any appropriate combination of the above. The computer-readable signal medium may further be any computer-readable medium other than the computer-readable storage medium. The computer-readable medium may send, propagate, or transmit a program used by or in combination with the instruction execution system, apparatus, or device. The computer program included in the computer-readable medium may be transmitted using any suitable medium, including but not limited to, a wireless medium, a wired medium, or the like, or any suitable combination of the above.

The flowcharts and block diagrams in the accompanying drawings illustrate system architectures, functions, and operations that may be implemented by an apparatus, a method, and a computer program product according to various embodiments of this application. Each box in a flowchart or a block diagram may represent a module, a program segment, or a part of code. The module, the program segment, or the part of code includes one or more executable instructions used for implementing specified logic functions. In some alternative implementations, functions annotated in the blocks may also be executed in an order different from that annotated in the accompanying drawings. For example, two boxes shown in succession may actually be performed basically in parallel, and sometimes the two boxes may be performed in a reverse order. This depends on the functions involved. Each block of the block diagrams or the flowcharts and combinations of blocks in the block diagrams or the flowcharts may be implemented by a dedicated hardware-based system configured to perform specified functions or operations, or may be implemented by a combination of dedicated hardware and a computer program.

The involved unit or module described in the embodiments of this application may be implemented by software or hardware, and the described unit or module may also be arranged in a processor. A name of the unit or module do not constitute a limitation on the units or modules in a specific case.

Another aspect of this application further provides a computer-readable storage medium, having a computer program stored therein, the computer program, when executed by a processor, implementing the method as described above. The computer-readable storage medium may be included in the electronic device described in the foregoing embodiments, or may exist alone without being installed into the electronic device.

Another aspect of this application further provides a computer program product, the computer program product including a computer program, the computer program being stored in a computer-readable storage medium. A processor of an electronic device reads the computer program from the computer-readable storage medium, and the processor executes the computer program, so that the electronic device performs the foregoing method provided in foregoing various embodiments.

Although a plurality of modules or units of a device configured to perform actions are mentioned in the above detailed description, such division is not mandatory. In fact, according to the implementations of this application, the features and functions of the two or more modules or units described above may be embodied in one module or unit. On the contrary, the features and functions of one module or unit described above may further be divided to be embodied by a plurality of modules or units.

A person skilled in the art may easily figure out another implementation of this application after considering the specification and practicing the implementations disclosed herein. This application is intended to cover any variations, uses, or adaptive changes of this application. These variations, uses, or adaptive changes follow general principles of this application and include the common general knowledge or common technical means in the technical field which are not disclosed in this application.

The foregoing descriptions are merely some exemplary embodiments of this application, and are not intended to limit the implementations of this application. A person of ordinary skill in the art may make corresponding variations or modifications with ease according to the main concept and spirit of this application. Therefore, the protection scope of this application needs to be subject to the protection scope of the claims.

What is claimed is:

1. A video detection method, performed by an electronic device, comprising:
extracting a plurality of video snippets of a target video;
extracting local features corresponding to the video snippets, respectively, based on motion information of a target object in the video snippets, the local features being configured for representing a time sequence inconsistency of the video snippets;
performing fusion operation on the local features to obtain a global feature of the target video; and
determining an authenticity probability of the target object in the target video based on the global feature, and obtaining a detection result of the target video based on the authenticity probability.

2. The method according to claim 1, wherein extracting the local features includes:
dividing the target object into a plurality of regions based on the motion information;
performing feature extraction on the video snippets, and integrating extracted features based on a time dimension, to obtain a plurality of time sequence convolution features; and
obtaining the local features of the video snippets based on the plurality of regions and the plurality of time sequence convolution features.

3. The method according to claim 1, wherein performing fusion on the local features includes:
calculating a self-attention feature among the video snippets based on the local features;
normalizing the self-attention feature to obtain an initial video feature; and
mapping the initial video feature through an activation function, to obtain the global feature of the target video.

4. The method according to claim 1, wherein determining the authenticity probability of the target object and obtaining the detection result includes:
inputting the global feature into a fully connected layer of a pre-trained video detection model to perform category discrimination on the global feature through the fully connected layer, to obtain the authenticity probability; and
determining that the target video is a fake video in response to a probability that the target object is fake is greater than a preset probability threshold.

5. The method according to claim 1, wherein:
extracting the local features corresponding to the video snippets includes extracting the local features through a video detection model; and
the video detection model is obtained through training in following manner:
obtaining a first real sample video snippet of a first real sample video, a reference sample video snippet of a reference sample video, and a fake sample video snippet of a fake sample video, the first real sample video and the reference sample video each being one of second real sample videos having different contents;
inputting the real sample video snippet, the reference sample video snippet, and the fake sample video snippet into a target model, to respectively obtain a real sample local feature of the real sample video snippet, the reference sample local feature of the reference sample video snippet, and a fake sample local feature of the fake sample video snippet;
constructing a local contrastive loss based on a result of contrasting the real sample local feature, the reference sample local feature, and the fake sample local feature; and
performing training based on the local contrastive loss to obtain the video detection model.

6. The method according to claim 5, wherein constructing the local contrastive loss includes:
constructing a local loss function based on a distance between the real sample local feature and the reference sample local feature and a distance between the reference sample local feature and the fake sample local feature; and
averaging the local loss function based on a quantity of real sample video snippets corresponding to the second real sample videos, to obtain the local contrastive loss.

7. The method according to claim 5, wherein inputting the real sample video snippet, the reference sample video snippet, and the fake sample video snippet into the target model, to respectively obtain the real sample local feature, the reference sample local feature, and the fake sample local feature includes:
inputting the real sample video snippet, the reference sample video snippet, and the fake sample video snippet into the target model, to obtain snippet feature vectors, generated by a convolutional layer of the target model, respectively corresponding to the real sample video snippet, the reference sample video snippet, and the fake sample video snippet;
dividing the snippet feature vectors based on a channel dimension, to obtain a feature vector;
inputting the feature vector into an adaptive pooling layer and two fully connected layers in the target model that are successively connected to each other, to generate a plurality of time sequence convolution features;
inputting the feature vector into a motion extraction layer, the fully connected layers, and a gamma distribution activation layer in the target model that are successively connected to each other, to divide the target object in the real sample video snippet, the reference sample video snippet, and the fake sample video snippet into a plurality of regions; and
obtaining the real sample local feature, the reference sample local feature, and the fake sample local feature based on the plurality of time sequence convolution features, the plurality of regions, and the feature vector.

8. The method according to claim 5, wherein performing training based on the local contrastive loss includes:
inputting the real sample local feature, the reference sample local feature, and the fake sample local feature into the target model, to obtain a real sample global feature of the first real sample video, the reference sample global feature of the reference sample video, and a fake sample global feature of the fake sample video;
constructing a global contrastive loss based on a result of contrasting the real sample global feature, the reference sample global feature, and the fake sample global feature; and
performing training based on the local contrastive loss and the global contrastive loss, to obtain the video detection model.

9. The method according to claim 8, wherein inputting the real sample local feature, the reference sample local feature, and the fake sample local feature into the target model, to obtain the real sample global feature, the reference sample global feature, and the fake sample global feature includes:
inputting the real sample local feature, the reference sample local feature, and the fake sample local feature into a self-attention module, a normalization layer, and an activation layer in the target model that are successively connected to each other, to obtain the real sample global feature, the reference sample global feature, and the fake sample global feature.

10. The method according to claim 8, wherein constructing the global contrastive loss includes:
constructing a global loss function based on a distance between the real sample global feature and the reference sample global feature and a distance between the reference sample global feature and the fake sample global feature; and
averaging the global loss function based on a quantity of the second real sample videos, to obtain the global contrastive loss.

11. The method according to claim 8, wherein performing training based on the local contrastive loss and the global contrastive loss includes:
inputting the real sample global feature, the reference sample global feature, and the fake sample global feature into the target model, to obtain a video classification result outputted by the target model based on the real sample global feature, the reference sample global feature, and the fake sample global feature;
constructing a classification loss of the target model based on the video classification result and a desired output result;
generating a total loss of the target model based on the local contrastive loss, the global contrastive loss, and the classification loss; and
adjusting a model parameter of the target model based on the total loss, to obtain the video detection model.

12. A non-transitory computer-readable storage medium, storing one or more computer programs that, when executed by one or more processors of an electronic device, cause the electronic device to perform the method according to claim 1.

13. An electronic device, comprising:
one or more processors; and
one or more storage apparatuses storing one or more programs that, when executed by the one or more processors, cause the electronic device to:
extract a plurality of video snippets of a target video;
extract local features corresponding to the video snippets, respectively, based on motion information of a target object in the video snippets, the local features being configured for representing a time sequence inconsistency of the video snippets;
perform fusion on the local features to obtain a global feature of the target video; and
determine an authenticity probability of the target object in the target video based on the global feature, and obtain a detection result of the target video based on the authenticity probability.

14. The electronic device according to claim 13, wherein the one or more programs, when executed by the one or more processors, further cause the electronic device to, when extracting the local features:
divide the target object into a plurality of regions based on the motion information;
perform feature extraction on the video snippets, and integrating extracted features based on a time dimension, to obtain a plurality of time sequence convolution features; and
obtain the local features of the video snippets based on the plurality of regions and the plurality of time sequence convolution features.

15. The electronic device according to claim 13, wherein the one or more programs, when executed by the one or more processors, further cause the electronic device to, when performing fusion on the local features:
calculate a self-attention feature among the video snippets based on the local features;
normalize the self-attention feature to obtain an initial video feature; and
map the initial video feature through an activation function, to obtain the global feature of the target video.

16. The electronic device according to claim 13, wherein the one or more programs, when executed by the one or more processors, further cause the electronic device to, when determining the authenticity probability of the target object and obtaining the detection result:
input the global feature into a fully connected layer of a pre-trained video detection model to perform category discrimination on the global feature through the fully connected layer, to obtain the authenticity probability; and
determine that the target video is a fake video in response to a probability that the target object is fake is greater than a preset probability threshold.

17. The electronic device according to claim 13, wherein:
the one or more programs, when executed by the one or more processors, further cause the electronic device to extract the local features through a video detection model; and
the video detection model is obtained through training in following manner:
obtaining a first real sample video snippet of a first real sample video, a reference sample video snippet of a reference sample video, and a fake sample video snippet of a fake sample video, the first real sample video and the reference sample video each being one of second real sample videos having different contents;
inputting the real sample video snippet, the reference sample video snippet, and the fake sample video snippet into a target model, to respectively obtain a real sample local feature of the real sample video snippet, the reference sample local feature of the reference sample video snippet, and a fake sample local feature of the fake sample video snippet;
constructing a local contrastive loss based on a result of contrasting the real sample local feature, the reference sample local feature, and the fake sample local feature; and
performing training based on the local contrastive loss to obtain the video detection model.

18. A system comprising a device that includes:
one or more processors; and
one or more storage apparatuses storing a video detection model and one or more programs, the one or more programs, when executed by the one or more processors, causing the device to:
input a global feature of a target video into the video detection model to perform category discrimination on the global feature to obtain an authenticity probability of a target object in the target video; and
obtain a detection result of the target video based on the authenticity probability.

19. The system according to claim 18, wherein:
the video detection model includes a fully connected layer; and
the one or more programs, when executed by the one or more processors, further cause the device to, when inputting the global feature into the video detection model:
input the global feature into the fully connected layer of the video detection model for the fully connected layer to perform category discrimination based on the global feature.

20. The system according to claim 18, wherein the one or more programs, when executed by the one or more processors, further cause the device to:
extract a plurality of video snippets of the target video; and
input the video snippets into the video detection model to extract local features corresponding to the video snippets, respectively, based on motion information of the target object in the video snippets, the local features being configured for representing a time sequence inconsistency of the video snippets;
perform fusion on the local features to obtain the global feature of the target video.
